(19) United States
(12) Patent Application Publication
(10) Pub. No.: US 2007/0227578 A1
(43) Pub. Date: Oct. 4, 2007

(54) Method for patterning a photovoltaic device comprising CIGS material using an etch process

(75) Inventors: Eric Perozziello, Half Moon Bay, CA (US); Peter Borden, San Mateo, CA (US)

Correspondence Address: Applied Materials, Inc., P.O. Box 450A, Santa Clara, CA, 95052, US

(73) Assignee: Applied Materials, Inc.

(21) Appl. No.: 11/395,080

(22) Filed: Mar. 31, 2006

(51) Int. Cl. H02N 6/00

(52) U.S. Cl. 136/244

(57) ABSTRACT

A processing method herein enables patterning a thin-film photovoltaic module into cells and/or sub-cells using an etch process. According to one aspect, an etch mixture is identified that is capable etching through a thin-film material such as CIGS with high selectivity to both photoresist and underlying layers such as metal. According to another aspect, the etch process enables patterning a photovoltaic device using lithographic techniques. Among other things, the invention enables forming interconnect structures with feature sizes that are substantially smaller than is possible with prior art techniques, and avoids many of the problems associated with laser and mechanical scribes, thus resulting in better and more efficient photovoltaic modules.

### FIELD OF THE INVENTION

The present invention relates generally to photovoltaic devices, and more particularly to a method for etching CIGS material in a manner that is suitable for application in patterning a photovoltaic module comprising a CIGS material.

### BACKGROUND OF THE INVENTION

Thin layers of material comprising Cu(In,Ga)Se, i.e. CIGS, are known to exhibit the highest photovoltaic conversion efficiency of any thin film material for a photovoltaic device (19.5%). Consequently, this is an attractive material for use in the manufacture of thin film photovoltaic panels.

In prior art processes, panels containing CIGS material are patterned to form a series-connected chain of cells in order to reduce the current. For example, a 1 m² panel at 12% efficiency would provide 120 watts of power. If the cell operating voltage is 0.6 volts, then the current is 200 amps, far in excess of what could be carried in the thin films used to contact the front and back of the cells. Moreover, since the ohmic loss is I²R (where I is the current and R the resistance), and since the thin conductive films have relatively high resistance, most of the power would be dissipated. However, if the module was divided into 300 stripes, for example, then the voltage would be 180 volts and the current 0.67 amps. The ohmic losses would be reduced by a factor of 90,000.

Laser and mechanical scribes are commonly used to divide the large area of material deposited on a module substrate into a number of cells and/or sub-cells. A top view of a typical module divided in this fashion is shown in FIG. 1. As shown in FIG. 1, a module 100 is divided into a plurality of cells 102 (i.e. stripes) that are series connected (e.g. electrically connected together in a horizontal direction in this drawing) via interconnects 104. The interconnects are formed in the module using scribes and conductors with processes that will be explained in more detail below. However, it should be noted here that the length L of such modules 100 can be 1 meter or more. Meanwhile, the width of the interconnects, which typically run almost the entire length L of the module, are typically around 700-1000 μm, and the width of the cells (i.e. stripes) are typically about 1 cm. As will be understood by those of skill in the art, FIG. 1 is a simplified, not-to-scale drawing of a typical module, and that the module can further include other passive and active components not shown in FIG. 1 such as electrodes, protect diodes, and terminals. Moreover, the module will typically also include external contacts and/or be environmentally encapsulated.

An example of a conventional process flow for patterning and interconnecting a module into cells and/or sub-cells is shown in FIGS. 2A-F. This flow is for a module made from a material such as CIGS, and FIGS. 2A-F could illustrate the process flow for a greatly enlarged portion 106 of FIG. 1 from the perspective of a cross-sectional side view of FIG. 1 taken across one of the interconnects 104. Accordingly, it should be understood that certain of the processing steps below will need to be repeated for each of the interconnects 104 in FIG. 1.

In the first step shown in FIG. 2A, a conducting metal 202 such as molybdenum is deposited on a substrate such as glass 204 using a vacuum sputtering system. In the second step shown in FIG. 2B, the metal 202 is laser scribed or mechanically scribed in a linear cut 206 across the module (as mentioned above, this cut might be >1 meter in length). As shown in FIG. 2C, a CIGS semiconductor layer 208 is then deposited. Next, as shown in FIG. 2D, a second scribe 210 parallel to the first cut 206 isolates the CIGS layer into individual cells. Then, as shown in FIG. 2E, a transparent conductive oxide (TCO) 212 is deposited; in one example the TCO is comprised of ZnO. Finally, as shown in FIG. 2F, a third scribe 214 is made to form the series connection 216, in which the ZnO from the deposition of layer 212 connects the top of one cell 218 to the bottom of the next cell 220.

The prior art patterning processes using laser and mechanical scribing such as that described above has a number of drawbacks that limit module efficiency. For example, they create wide scribes, defects, and shunt current paths. Furthermore, they provide limited means for wiring the module in series-parallel arrangements that might reduce sensitivity to shading losses or non-uniformity.

For these and other reasons, the present inventors have recognized that it would be attractive to consider lithographic patterning processes to divide a module into cells and/or sub-cells and to form interconnects between them. Such processes could provide the ability to form more sophisticated interconnect patterns that can include features such as series-parallel wiring and pads for protect diodes and internal contacts. However, these processes would require the ability to etch CIGS, and, in some cases, to do so selectively so that the etch stops at the underlying Mo.

The literature contains only limited references to performing etches in connection with CIGS material, and these references are limited to specific purposes that are not useful for patterning modules such as finishing the surface of a CIGS layer or reducing surface defects. Known etches include 0.5% Br in methanol, referenced for the purpose of preparing a CIGS layer surface in order to form a contact. See, E. Schlenker et al., “Schottky Contacts on Cu(In,Ga)Se₂ Thin Films,” Proc. of the 20^{th} European Photovoltaic Solar Energy Conf., (2005) 4AV.1.19.

KCN has also been reported as a possible surface treatment solution, in this case as part of a process to lay down a buffer layer. See P. Johnson, et al., “Effects of Buffer Layers on SSI CIGSS-Absorber Transient I-V and C-V Behavior,” Presented at 28^{th} IEEE Photovoltaics Conf., Sep. 17-22, 2000. In addition to not being useful as a complete etch, it should be noted that use of KCN in production may be impractical because of safety considerations associated with the high toxicity of this substance.

Other prior art includes various surface treatment etches for the purpose of increasing the device open circuit voltage. For example, in V. K. Kapur, et al., “Lab to Large Scale Transition for Non-Vacuum Thin Film CIGS Solar Cells,” NREL Phase II—Annual Technical Report August 2003-July 2004, NREL January 2005, the authors report includes a section listing various types of surface treatment etches.

As should be apparent, none of these conventional processes are useful for etching or patterning a thin film CIGS layer, which requires rapidly etching completely through two or more microns of CIGS, as opposed to a surface treatment which slowly removes a few angstroms from the surface.

In addition to surface treatments, other conventional processes cannot obtain a CIGS etch useful for patterning. For example, CSG Solar has reported on their web site (www.csgsolar.com) a process to form contact holes in re-crystallized silicon films on glass that uses a wet etch through a resist film that selectively etches p-type silicon but not n-type silicon. The film is patterned using ink-jet application of developer, not with lithography. Use of ink-jet forces use of larger features, which is acceptable for contact holes, but not long grooves. Also, throughput is limited for long grooves, as are used to isolate cells in modules. Moreover, in silicon wafer processing a number of chemical mixtures are in common use. One mixture is called Piranha, which is H₂SO₄:H₂O₂ in various ratios. This is used as a pre-clean (not a patterning etch) to remove surface organics and photoresist residues.

Therefore, there remains a need in the art to overcome many of the shortcomings of the conventional processes for separating and forming cells in a thin-film photovoltaic device having CIGS material. The present invention aims at doing this, among other things.

### SUMMARY OF THE INVENTION

The present invention provides a method of patterning a thin-film photovoltaic module into cells and/or sub-cells using an etch process. According to one aspect, an etch mixture is identified that is capable etching through a thin-film material such as CIGS with high selectivity to both photoresist and underlying layers such as metal. According to another aspect, the etch process enables patterning a photovoltaic device using lithographic techniques. Among other things, the invention enables forming interconnect structures with feature sizes that are substantially smaller than is possible with prior art techniques, and avoids many of the problems associated with laser and mechanical scribes, thus resulting in better and more efficient photovoltaic modules.

In furtherance of these and other objects, a method according to the invention includes preparing a photovoltaic thin film, preparing an etch mixture that is capable of etching the thin film, and using the etch mixture in an etch process to completely etch through the thin film. In certain embodiments the method can further include defining a mask for the thin film, wherein the etch process is performed using the defined mask to pattern the thin film. In certain embodiments, the preparing step includes preparing the thin film on an underlying metal, wherein a rate at which the etch process removes the thin film is greater than a rate at which the etch process removes the underlying metal. In certain embodiments, the mask defining step includes coating the thin film with photoresist, and exposing portions of the photoresist to define the mask, wherein a rate at which the etch process removes the thin film is greater than a rate at which the etch process removes the photoresist.

In additional furtherance of these and other objects, a method of processing a thin film photovoltaic module includes preparing a module including preparing a thin film on a substrate, and dividing the module into cells, including etching the thin film using an etch process. In certain embodiments, the method further includes defining a mask for the thin film, wherein the mask corresponds to the cells into which the module is to be divided, and wherein the etch process is performed using the defined mask. In certain embodiments, the method further includes using an etch and patterning process to form test structures in the thin film.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a top view of a conventional module of thin film photovoltaic cells separated by interconnects;

FIGS. 2A-F show a conventional process of forming an interconnect between thin film photvoltaic cells;

FIG. 3 is a flowchart illustrating an example CIGS etch process according to the invention;

FIG. 4 is a flowchart illustrating an example method of patterning a photovoltaic device using a CIGS etch process in accordance with the invention; and

FIGS. 5A-I show a method of forming an interconnect for a photovoltaic module using a CIGS etch process in accordance with an embodiment of the invention.

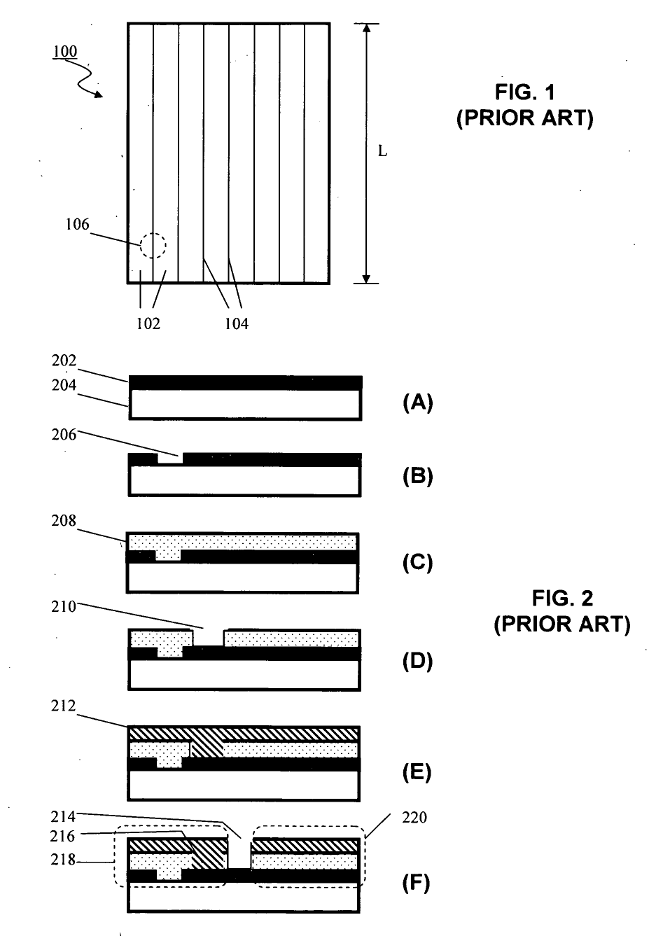

### DESCRIPTION OF REFERENCE NUMERALS ON THE DRAWINGS

The following describes the reference numerals used on the drawings. This description is intended to be illustrative rather than limiting and those skilled in the art will appreciate that various substitutions and modifications can be made while remaining within the scope of the invention:
100 module
102 cell
104 interconnect
106 interconnect detail area
202 conductor
204 substrate
206 first scribe
208 semiconductor
210 second scribe
212 TCO
214 third scribe
216 series connection
218 first cell
220 next cell
500 stack
502 substrate
504 underlying metal
506 semiconducting layer
510 photoresist layer
512 mask
514 aperture
516 conducting step
518 exposed areas
520 insulator
522 transparent conductor
524 metal connector
530 interconnect groove
540 isolation groove

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Generally, the present inventors have discovered several wet etch solutions that can effectively etch through a layer of CIGS material with high selectivity to an underlying metal such as Mo. The present inventors have further discovered how these mixture can be used in an etch process including a photoresist so that feature sizes available through conventional lithographic methods can be obtained for interconnects and other structures in a photovoltaic device comprising a CIGS material.

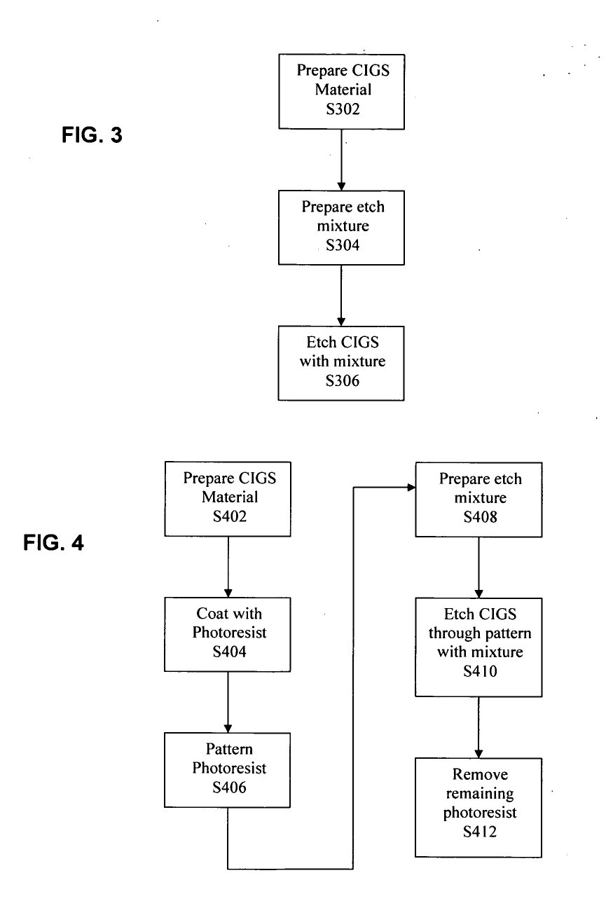

FIG. 3 is a flowchart illustrating one example method of etching a CIGS material, with particular usefulness for implementation in a photovoltaic cell structure, in accordance with the principles of the invention.

As shown in step S302, the process includes preparing the CIGS material. In one example, this involves growing a CIGS material to a thickness on the order of 2 μm on a Mo layer. Mo provides a good ohmic contact with CIGS and has a similar thermal coefficient of expansion, which can be important for the elevated temperature of CIGS deposition. The Mo is usually deposited on a substrate material, which may be, for example, glass, stainless steel, or plastic. In some cases, Mo foil is used to which the CIGS can then be deposited.

It should be noted that additional layers of other materials can be included in addition to the CIGS material, which together with the CIGS material can be considered to comprise a thin film or semiconductor layer in a photovoltaic module. For example, one or more buffer layers may also be included, such as a 0.07 μm buffer layer of CdS, as part of the cell structure to protect the interface at the CIGS surface. In other embodiments, protect layers using materials such as SiO, SiO₂, Si₃N₄ may also be deposited. These layers may also be sacrificial, wherein they may be removed before additional solar cell layers are deposited.

As for the CIGS material layer, a range of concentrations of Cu, In, Ga and Se is used, and sometimes the Ga is absent or sulfur may be added. Any one of a variety of CIGS materials or processes known in the art may be used, for example as described in Y. Hamakawa (ed.), “Thin-Film Solar Cells,” Chapter 10 (2004), the contents of which are incorporated herein by reference. Thus, the term CIGS is used herein in its broadest possible context of CIGS and similar or related films. In addition, other materials may be used for thin film photovoltaic modules, either individually or in combination. These include CdTe, amorphous silicon (a:Si), and micro- or nano-crystal silicon (μc:Si).

A next step S304 as shown in FIG. 3 includes preparing the etch mixture. One example embodiment of an etch mixture according to the invention is 5 parts of 99% H₂SO₄ to 1 part 30% H₂O₂. The inventors have discovered that this mixture exhibits an effective etching ability through CIGS while being highly selective to metals such as Mo (i.e. the etch rate of CIGS is higher than Mo). Next, in step S306, the CIGS material is etched using the mixture. In general, an etch rate of 10 Å/sec is a minimum acceptable rate, as this would require about 33 minutes to etch through 2 μm of CIGS material. However, higher rates are preferred, such as 50 Å/sec, which would perform the same etch in less than 7 minutes. These rates are readily obtained through selection of the ratio of H₂SO₄ to H₂O₂ etch components as will become apparent to those skilled in the art from the descriptions provided herein.

It is believed that the chemistry of the H₂SO₄+H₂O₂ etch mixture acts on the CIGS in several ways. CIGS is typically about 50% Se, and the Se reacts with the hydrogen of the acid to evolve H₂Se, which is a gas. H₂Se is toxic, so the process is preferably carried out under a fume hood. The copper, indium and gallium can react with the sulfate ion (SO₄⁺²) to form sulfates that are soluble in the etch bath.

The invention is not limited to using an etch mixture of H₂SO₄+H₂O₂. Rather, the present inventors have discovered that other etch systems will provide sufficient etch rates and selectivity to pattern CIGS, and that these generally require an acid. For example, the inventors have found that a mixture of H₂SO₄ and HNO₃ (which probably acts as an oxidizer) by itself will not etch CIGS, but diluting the same mixture with approximately equal parts of water will etch CIGS at a rapid rate. Such dilution may be required because the etch products are not soluble in the concentrated acids, but are soluble in water.

It should be noted that other wet etch solutions may be possible, as well as dry etch processes. Although dry etches are commonly used in lithographic processing, they are generally more costly than wet etches. Dry etches usually involve chemical reactions using ions in a plasma to create volatile by-products. An advantage of the wet etch process examples provided herein is that they include the use of inexpensive chemicals such as sulphuric acid and hydrogen peroxide. Moreover, it is worth noting that copper has no previously known dry etch.

FIG. 4 is a flowchart illustrating a method for patterning a CIGS material, for example as included in a photovoltaic module structure, using an etch process in accordance with the principles of the invention.

Initial step S402 of preparing the CIGS material can be the same as step S302 above, which, for example, includes growing a 2 μm layer of CIGS material on a metal such as Mo. Differently from the process in FIG. 3, however, as shown, a next step S404 includes coating the material with a photoresist using, for example a spray, dip or roll-on process. The thickness may be 1-10 μm and an example photoresist that provides desirable selectivity as will be explained in more detail below is Shipley 3612 photoresist. In some embodiments, the substrate may be coated with an adhesion promoter such as hexamethyldisilizane (HMDS) before applying the resist. In a next step S406, the photoresist is patterned in accordance with a desired corresponding pattern for the CIGS etch. In one example, 30 μm wide lines are exposed in the photoresist using a mask suspended about 10 μm above or in contact with the substrate containing the CIGS material. The exposed resist is developed and baked/cured to complete the pattern.

Next in step S408, an etch mixture is prepared, such as the H₂SO₄+H₂O₂ mixture or the H₂SO₄+HNO₃ mixture diluted with water as described above. In step S410, the mixture is used to etch the CIGS material through the patterned photoresist. In this step, it is preferable that the mixture be used at a sufficiently low temperature to limit erosion of the photoresist mask. For example, a temperature of about 40 degrees C. will provide about a 25:1 etch selectivity between CIGS and Shipley 3612 photoresist.

In general, it is desirable to have etch rate ratios between CIGS and both the underlying metal layer and the photoresist, that will provide a wide enough process window to mask the etch and stop it at the underlying metal, while still making it possible to completely cut through the CIGS layer so as to pattern the substrate. Using the etch solutions in conditions described above, the inventors have found that the desired overall process window can be achieved with the described layers of CIGS, Mo and Shipley 3612 photoresist.

However, it should be noted that various etch rate ratios among the resist, CIGS and underlying metal layers can be included to achieve the overall etch process window, and in general it is preferred to have the etch rate of CIGS is greater than the etch rate of both the resist and underlying metal. For example, if the etch solution provided only a 4:1 etch rate ratio between CIGS and photoresist, and if the CIGS layer and photoresist layer were 2 μm and 10 μm respectively, an acceptable 20:1 etch process ratio would be possible due to the relative differences in layer thicknesses, and thus provide the desired window.

The desired process window can be affected and/or controlled by many factors apparent to those skilled in the art. For example, if a large substrate is etched in a dip tank, then the time between when the first edge of the substrate enters the bath and when the substrate is fully immersed partially determines the process window. Or in another case, the time between when the substrate is withdrawn and the etching is fully quenched in a water rinse will also contribute to the process window, as etching may not be uniform in the time between withdrawal and quenching. The process window, therefore, can be considered a time margin allowing for the inability to apply a process to all parts of the substrate for exactly the same time. The process window can also be used to account for process nonuniformity, such as variation in resist thickness and variations in etch rates as the etch solution ages. Those skilled in the art will understand how the overall process window can be obtained in various ways after being taught by the present invention.

In an alternate embodiment, a thin film of SiO₂ or Si₃ N₄ is deposited on the substrate and patterned using photoresist. The photoresist is then removed and the thin film is used to mask the CIGS etch.

Finally in step S412, the remaining photoresist is removed so the patterned CIGS material can be subjected to further processing, for example.

It should be noted that the methods described in connection with FIGS. 3 and 4 can be applied to pattern thin film photovoltaic materials other than CIGS. For example, films such as CdTe, amorphous silicon, and micro- or nano-crystal silicon are also used in thin film photovoltaic devices.

The present inventors have experimentally tested the etch process described above and have obtained isolated CIGS feature sizes of approximately 10 um.

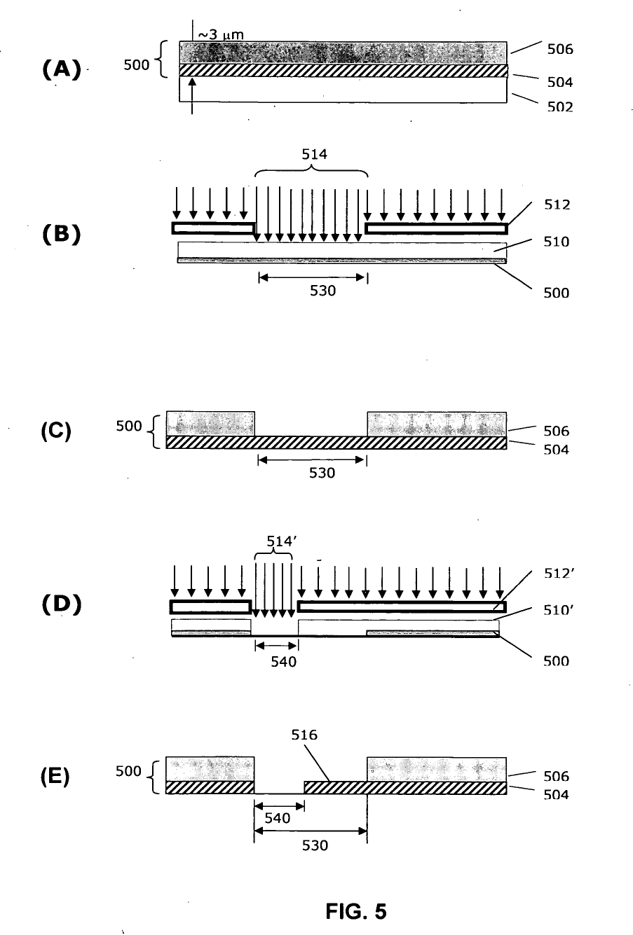

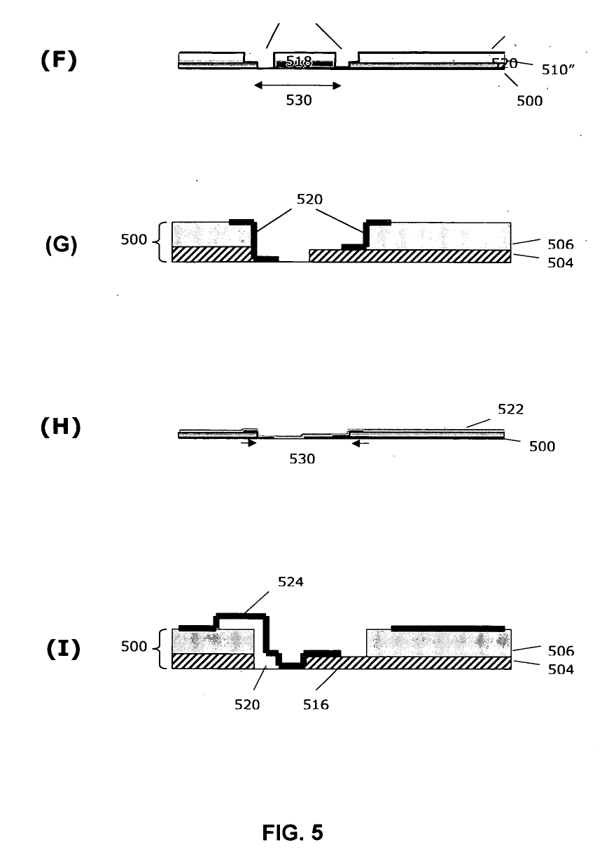

An example process flow for dividing and forming interconnects in photovoltaic devices that incorporates the CIGS etch process according to invention is illustrated in FIGS. 5A-I. Other possible examples of implementing the etch process of the invention are described in more detail in co-pending application No. ______ (AMAT-10742), the contents of which are incorporated herein by reference. It should be noted that the below drawings are not to scale, and relative dimensions of various layers and features will be specified in the descriptions where examples are appropriate. The drawings are intended for illumination rather than limitation.

The steps shown in FIGS. 5A to 5C can be similar to those described in connection with FIG. 4. Accordingly, in the first step shown in FIG. 5A, the starting material is a photovoltaic stack 500 on a substrate 502 such as a 3mm thick sheet of glass. In one embodiment, stack 500 includes a 0.1 μm layer 504 corresponding to the opaque metal electrode—typically molybdenum—in contact with the glass substrate 502, and a 2 μm layer 506 of CIGS. The initial stack of this embodiment does not include a top transparent conductor; however one can be added later, and it can be included in the initial stack in other alternative embodiments as described in the co-pending application No. ______ (AMAT-10742).

In the next step shown in FIG. 5B, stack 500 is coated with a photoresist 510 using, for example a spray, dip or roll-on process. The thickness can be 1-10 μm and the material can be Shipley 3612. As further shown in FIG. 5B, 30 μm wide lines are exposed in the photoresist through an aperture 514 of a mask 512 suspended about 10 μm above or in contact with the stack 500. The exposed resist is developed to complete the pattern.

Next in the step shown in FIG. 5C, an etch mixture, such as a H₂SO₄+H₂O₂ mixture or H₂SO₄+HNO₃ mixture diluted with water as described above, is used to etch the CIGS material 506 through the patterned photoresist down to the underlying metal layer 504, and the mask is stripped. This forms a 30 μm wide interconnect groove 530 through the CIGS layer 506, which can partially or fully run the length of the module (e.g. 1 m). It should be apparent that other lines, substantially parallel to this groove and spaced apart by about I cm can also be formed in these steps to define the stripes in the module.

In the next step shown in FIG. 5D, a photoresist layer 510′ is re-applied and exposed through aperture 514′ in mask 512′ suspended over the stack 500. In this embodiment, aperture 514′ is aligned to the opening previously formed through the CIGS layer and down to the underlying conductor. As shown in this example, aperture 514′ defines a 10 μm opening that is aligned to the left edge (with respect to the orientation of the drawing) of the 30 μm groove 530 through the CIGS layer formed in the previous etch step. The exposed photoresist is developed and the underlying metal layer is etched to form a 10 μm isolation groove 540 (which like the interconnect groove 530 can run the length of the module, e.g. 1 m). For Mo, an etch such as PAN (phosphoric acid, acetic acid and nitric acid H₃PO₄+CH₃COOH+HNO₃) can be used.

The etch process described above forms the conductive step 516 shown in FIG. 5E. As noted above, the lithographic processing flow enabled by the CIGS etch process of the present invention allows very narrow interconnects between cells to be formed. In this example, the interconnect grooves 530 are about 30 μm wide, as opposed to 700-1000 μm in the prior art.

In the next step shown in FIG. 5F, an insulator is applied to the exposed edges or walls of the CIGS semiconductor layer adjacent to the interconnect groove 530 between cells. More specifically, in the embodiment shown in FIG. 5F, resist 510″ is deposited and then patterned to expose the CIGS edges through openings 518. As should be apparent, an aligned lithographic process such as that described in FIGS. 5B and 5D can be performed. In this example, a lift-off resist such as ProLift 100 from Brewer Science is preferably used, as will become more apparent from below. A thin insulator layer 520 such as SiO₂ or Al₂O₃ is then sputtered to a thickness of 500 Å.

Removing the photoresist lifts off the insulator deposited thereon, leaving portions of insulator 520 on the opposing walls of the CIGS layer adjacent to the interconnect groove 530 that were exposed through openings 518, as shown in FIG. 5G.

A layer 522 of a transparent conductor such as 0.7 μm of aluminum doped zinc oxide (AZO) is deposited over the surface of the stack 500 in a next step shown in FIG. 5H.

In a next step shown in FIG. 51, the layer 522 is patterned (e.g. using lithographic techniques as described in FIGS. 5B and 5D, for example), to form a series connection 524 between adjacent cells. As shown in FIG. 51, the insulator material 520 underlies the connection 524, thus eliminating the current shunt path formed when the conductor covers the edge of the cell.

In other embodiments, the step shown in FIG. 5B first exposes the isolation cut 540 (rather than the wider interconnect cut 530) to the substrate (as in FIG. 5D). The semiconductor is etched, followed by a conductor etch. A wider region is exposed and etched only through the semiconductor, thereby forming the step 516 (in effect reversing the exposures in FIGS. 5B and 5D). In another embodiment, different methods are used to form the insulator on the edges shown in FIG. 5G. In one embodiment, a blanket insulator is deposited following the step shown in FIG. 5E. The reverse pattern of the patterned resist shown in FIG. 5F is used, and the insulator is etched away everywhere except on the steps. In another embodiment, a mask such as that used in connection with FIG. 5F is not applied, and a blanket insulator is anisotropically dry etched to leave insulator coating the vertical walls, as in a MOSFET spacer process. Many other possible alternative embodiments will become apparent to those skilled in the art after being taught by the present specification.

It should be noted that, in addition to dividing cells and forming interconnects, the etch and patterning processes described above can be used to form test structures, for example, adjacent to the active area, or even in a small portion of the active area. For example, the etching can be used to isolate a small portion of a deposited film, so that properties such as thickness or conductivity can be measured. In some cases, an earlier deposition may be etched away in an earlier process step, so that a later deposition is formed on the glass substrate, allowing the later deposition to be electrically isolated, with underlayers absent. This allows intermediate process parameters to be measured by probing before the full process is complete, much like a conventional IC or semiconductor process.

The CIGS etch and patterning process of the invention may also be used for other purposes. For example, the process can be used to form contact pads or to place small surface-mount protect diodes. In addition, it is possible to perform the process of edge isolation while performing the cell division using the CIGS etch process of the invention. Edge isolation is the process of removing deposited layers from the edges of the module, so they will not run over the edge and short out. This process is normally done using laser scribing, but can be included in the cell division etch process (e.g. as shown in FIGS. 5D and 5E) by adjusting the mask to expose the periphery of the module. In addition, an insulator such as insulator 520 can be formed over the edge isolation at no additional cost in order to passivate the exposed edge, thus reducing edge leadage and making the exposed edge impervious to contamination.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method comprising:
preparing a photovoltaic thin film;
preparing an etch mixture that is capable of etching the thin film; and
using the etch mixture in an etch process to completely etch through the thin film.

2. A method according to claim 1, further comprising: defining a mask for the thin film,
wherein the etch process is performed using the defined mask to pattern the thin film.

3. A method according to claim 1, wherein the etching step includes using a wet etch process.

4. A method according to claim 1 wherein the photovoltaic film comprises CIGS.

5. A method according to claim 1 wherein the photovoltaic film comprises CdTe.

6. A method according to claim 1 wherein the photovoltaic film comprises amorphous silicon.

7. A method according to claim 1 wherein the photovoltaic film comprises micro- or nano-crystal silicon.

8. A method according to claim 3 wherein the wet etch process includes at least one acid.

9. A method according to claim 8 wherein the acid comprises H₂SO₄.

10. A method according to claim 9 wherein the wet etch process further includes an oxidizer.

11. A method according to claim 10 wherein the oxidizer comprises H₂O₂.

12. A method according to claim 10 wherein the oxidizer comprises HNO₃.

13. A method according to claim 3, further comprising diluting an etch solution with water to increase the etch rate.

14. A method according to claim 1, wherein the etching step includes etching through the thin film at a rate that exceeds 5 Å/sec.

15. A method according to claim 1, wherein the etching step includes etching through the thin film at a rate that exceeds 50 Å/sec.

16. A method according to claim 1, wherein the preparing step includes preparing the thin film on an underlying metal, and wherein a rate at which the etch process removes the thin film is greater than a rate at which the etch process removes the underlying metal.

17. A method according to claim 16 wherein the underlying metal comprises Mo.

18. A method according to claim 2 wherein the mask defining step includes coating the thin film with photoresist; and
exposing portions of the photoresist to define the mask.

19. A method according to claim 18, wherein a first rate at which the etch process removes the thin film is greater than a second rate at which the etch process removes the photoresist.

20. A method according to claim 19, wherein the first rate is at least 5 times greater than the second rate.

21. A method of processing a thin film photovoltaic module, comprising:
preparing a module including preparing a thin film on a substrate; and
dividing the module into cells, including etching the thin film using an etch process.

22. A method according to claim 21, further comprising:
defining a mask for the thin film,
wherein the mask corresponds to the cells into which the module is to be divided,
and wherein the etch process is performed using the defined mask.

23. A method according to claim 22, wherein the mask defining step includes
coating the thin film with photoresist; and
exposing portions of the photoresist to define the mask.

24. A method according to claim 21, further comprising:
using an etch and patterning process to form test structures in the thin film.

25. A method according to claim 21 wherein the thin film comprises CIGS.

26. A method of processing a thin film photovoltaic module, comprising:
preparing a module including preparing a thin film on a substrate; and
performing edge isolation for the module, including etching the thin film to remove the thin film in areas at peripheral edges of the module using an etch process.

27. A method according to claim 26, further comprising:
defining a mask for the thin film,
wherein the mask corresponds to the areas at edges of the module where isolation is desired,
and wherein the etch process is performed using the defined mask.

28. A method according to claim 26, further comprising depositing an insulator to passivate the module in the areas where the thin film has been removed.
